(19) United States
(12) Patent Application Publication
(10) Pub. No.: US 2007/0009313 A1
(43) Pub. Date: Jan. 11, 2007

(54) Soap

(76) Inventor: Jannine Benkhardt, Hamburg (DE)

Correspondence Address: Friedrich Kueffner, Suite 910, 317 Madison Avenue, New York, NY, 10017, US

(21) Appl. No.: 11/450,128

(22) Filed: Jun. 10, 2006

(30) Foreign Application Priority Data
Jun. 11, 2005 (DE) 10 2005 027 153.7
Jun. 9, 2006 (DE) 20 2006 009 241.2

(51) Int. Cl. B43K 24/02

(52) U.S. Cl. 401/100

(57) ABSTRACT

A two- or three dimensional moulded body (21) with a figurative conformation (22) or with a geometrical conformation (23) is placed in a soap body (11) of a soap (100 made of a translucent or a not translucent soap mass, whereby at least one luminous means (30) and/or a speech and/or music module (60) are placed in the moulded body (21), the luminous means (30) is connected to a power supply and can be activated and time-controlled by means of a control device (50) with a first on-off switch or a motion switch (51) which again is operatively connected to a second on-off switch (55).

### FIELD OF APPLICATION

This invention refers to a soap according to the preamble of claim 1.

### AIM, SOLUTION, ADVANTAGE

The aim of this invention is to create a soap with devices for the reproduction of optical and/or acoustic information relaying and signs with a certain meaning.

This aim is achieved with a soap of the type according to the species with the characteristics indicated in claim 1.

Accordingly the invention consists in that a two- or three-dimensional moulded body with a figurative conformation or with a geometrical conformation is placed in the soap body, whereby at least one luminous means and/or a speech and/or music module are placed in the moulded body, the luminous means is connected to a power supply and can be activated and time-controlled by means of a control device with a first on-off switch or a motion switch which again is operatively connected to a second on-off switch.

A further embodiment of the invention consists in that a representational two- or three dimensional insert body in form of a figurative conformation or of a moulded body with a geometrical conformation is placed in the soap body, whereby at least one luminous means, preferably a number of lamps or luminescent diodes emitting colour light or white light in form of a time-controlled running light circulating by means of a control device is placed in the inner space of the moulded body.

According to the invention, an acoustic component in form of a speech and/or music module is placed besides the light optics placed in the representational insert body, i.e. in the soap body or in its insert body. This brings the advantage that a speaking soap or a music emitting soap is created, the speech and/or music module of which and/or the luminescent diodes are set in motion by a movement of the soap or by activation of the motion switch by an on-off switch so that when using the soap music or spoken texts sound. If the soap is used up, the component with the speech and/or music module and/or the luminescent diodes can continued to be used, all the more since for a figurative embodiment of the insert body a speech and/or music module is lodged in a housing which can react.

The housing can also have a geometrical configuration, for example the shape of a cube, of a right parallelepiped or the like.

The combination of the acoustic component with the light optical component and the arrangement thereof in the inner space of the three-dimensional insert body brings the advantage that besides a light emission a speech and/or music reproduction is possible by means of the speech and/or music module.

Advantageous embodiments of the invention are characterized in the subclaims.

The invention provides that the figurative moulded body or the moulded body which has a geometrical conformation is provided as a hollow body with an impermeable or moisture-proof closable opening. It is particularly advantageous that the motion switch can be switched on by a mechanical on-off switch and is locked for transport.

The figurative moulded body can be placed in the inner space of an envelope which is configured two- or three-dimensional. The moulded body which has a geometrical conformation or the envelope consists according to a further embodiment of two half-shell components which can be stuck together which are preferably connected impermeable and moisture-proof to each other.

The figurative moulded body can be placed together with a liquid medium in the inner space of the geometrical moulded body which is configured as a closed hollow body so that an aquarium-type conformation is obtained.

At least one luminous means such as a luminescent diode, a power source such as a battery and a first on-off switch activated by motion are placed in the inner space of the moulded body configured as a hollow body between the luminous means and the power source, this first on-off switch being again activated by a second on-off switch.

The device for the reproduction of information which is configured as a speech and/or music module for the acoustic reproduction of sounds and/or emission of light is placed in the moulded body configured as a hollow body.

The reproduction of acoustic sounds and/or emission of light is possible by means of the speech and/or music module. Thus a possibility is advantageously created to reproduce information even for soaps which are not completely translucent. The intensity of the emission of acoustic sounds or light can be designed such that not translucent soaps can also be penetrated through by them and that the reproduction is independent of external conditions. The soap according to the invention thus constitutes itself an active object for reproducing information. According to the invention, by information all the acoustic or optically active signals emitted by the soap or the speech and/or music module are understood as information, independently from the fact if they have a meaning for an observer.

The speech and/or music module can be placed inside the soap body so that the information can be reproduced independently from the place of storage of the soap and the speech and/or music module does not impair the use of the soap. Furthermore the function can be used up to the using up of the soap. Moreover the speech and/or music module is placed in the two- or three dimensional representational insert body configured as a hollow body in form of a figurative moulded body or of a moulded body with a geometrical conformation so that the speech and/or music module can be used further even after the soap has been used up.

The speech and/or music module is preferably activable by motion and/or contact of the soap after the provided motion switch has been activated. Moreover it can be deactivated in a predetermined position such as, for example, in a predetermined deposit position. This function can be achieved particularly simply by a motion sensor assigned to the speech and/or music module which emits a signal depending on movements of the soap itself or of external movements. Alternatively or complementarily other sensors such as sensors for detecting biometric data or light-sensitive sensors can be provided. The activation of the speech and/or music module takes place only when the soap is being used or if external values are detected correspondingly so that the time of activation of the speech and/or music module is considerably reduced and thus the working life of the speech and/or music module is considerably prolongated.

The acoustic sounds can be configured as a predetermined sequence of sounds such as for example a melody, an advertisement slogan or also as an indication for use or a warning or an expression of thanks. This sequence of sounds is stored in a storage unit assigned to the speech and/or music module and can be reproduced over an acoustic reproduction device when a movement is detected.

Alternatively the speech and/or music module can also comprise an active, i.e. an energy supplied, part and a currentless passive part. The passive part is then preferably assigned to the soap since this part is insensitive to the lye and moisture of the soap. The passive part can be configured as a magnet or also as a transponder. The active part is then placed outside the soap and must not be configured moisture-proof so that it can be realized as a cheap item. The speech and/or music module can complementarily or alternatively also have a protecting envelope so that an additional protection is given.

Luminescent diodes which are particularly economical with respect to consumption and durable and moreover particularly intensive due to the emission of practically monochromatic light are preferably used for the restitution of the light. The colour of the luminescent diodes can be adapted to the colour of the soap so that the effect of the light emission is attenuated as little as possible by the soap body. Red luminescent diodes could for example be placed in red soaps so that there results a bright red soap for the observer even in dark rooms.

The light can be emitted in form of pulses which again can be adapted to the sounds of the speech and/or music module. For example a rhythmic sequence of sounds could be optically underligned with this.

### SHORT DESCRIPTION OF THE DRAWINGS

Embodiments of the invention will be explained below with reference to the drawings.

FIG. 1 shows partly as a view, partly as a graphic, a soap with an integrable representational moulded body or a moulded body which has a geometrical configuration which has a running light and/or with a speech and/or music module.

FIG. 2 shows a vertical section according to line II-II in FIG. 1 of a soap with a representational moulded body integrated in the soap and configured as a hollow body in form of a fish.

FIG. 3 shows partly as a view, partly in a vertical section in an enlarged reproduction the moulded body according to FIG. 2 with colour emitting luminescent diodes placed in its inner space with a running light control and with a speech and/or music module.

FIG. 4 shows a view from above of a switchboard with a certain number of colour luminescent diodes.

FIG. 5 shows in a vertical section a soap with an integrated moulded body configured as a hollow body with a liquid medium placed in its inner space and with a representational moulded body configured as a fish.

FIG. 6 shows a schematic view of a module for the reproduction of acoustic sounds.

FIG. 7 shows a schematic representation of a soap with a module for the reproduction of acoustic sounds with a passive part and an externally placed active part.

FIG. 8 shows a circuit for alternately on and off switchable colour luminescent diodes.

FIG. 9 shows a circuit for colour luminescent diodes with a running light control.

### DETAILED DESCRIPTION OF THE INVENTION AND BEST WAY FOR CARRYING OUT THE INVENTION

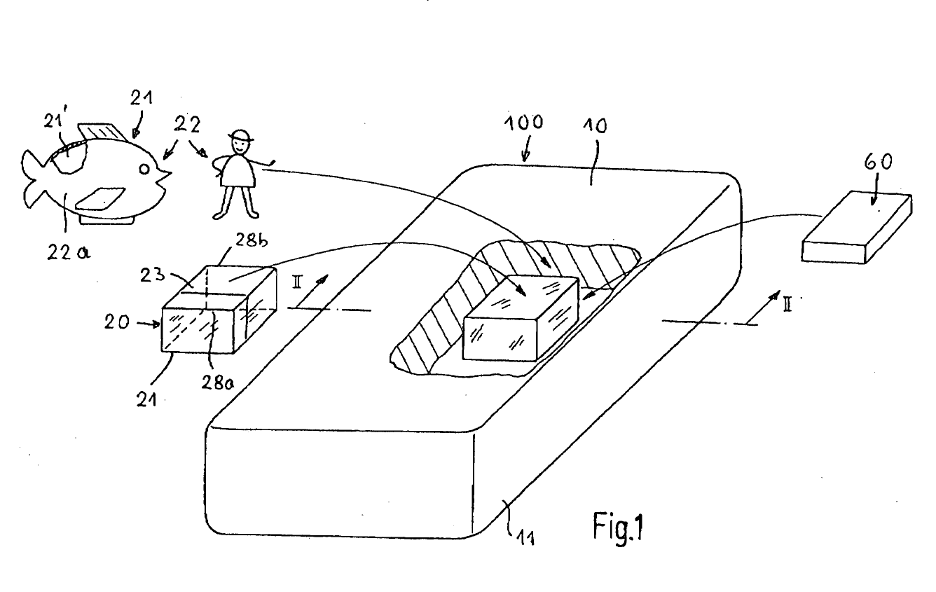

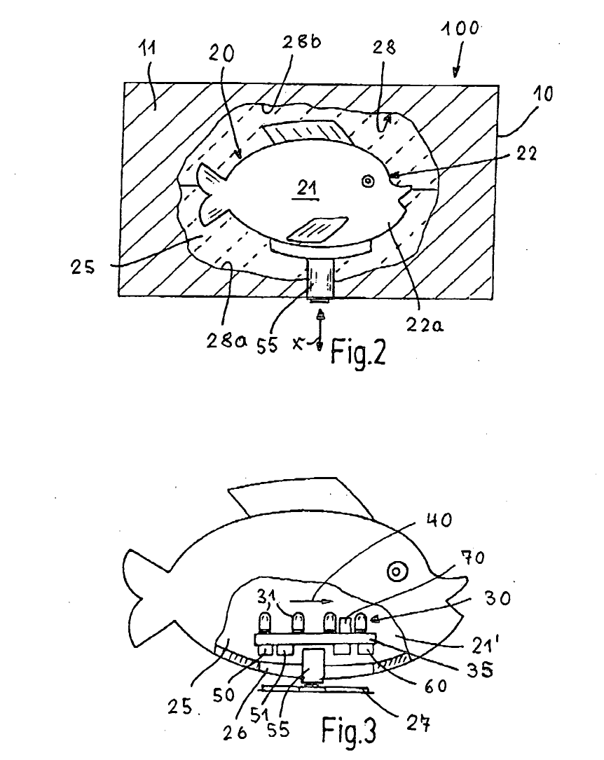

The soap 100 configured according to the invention comprises according to FIG. 1 a soap 10 with a soap body 11 made of a translucent or clear or non translucent soap mass. A representational two or three-dimensional insert body 20 in form of a figurative conformation 22 or of a moulded body 21 which has a geometrical conformation 23 is placed in the soap body 11. For the embodiment shown in FIG. 2 and 3, the figurative conformation 22 of the moulded body 21 is made of a fish FIG. 22a. However the moulded body 21 can also have other figurative conformations. For the geometrical conformation 23 of the moulded body 21 the matter is of bodies with the shape of a cube, of a right parallelepiped or the like.

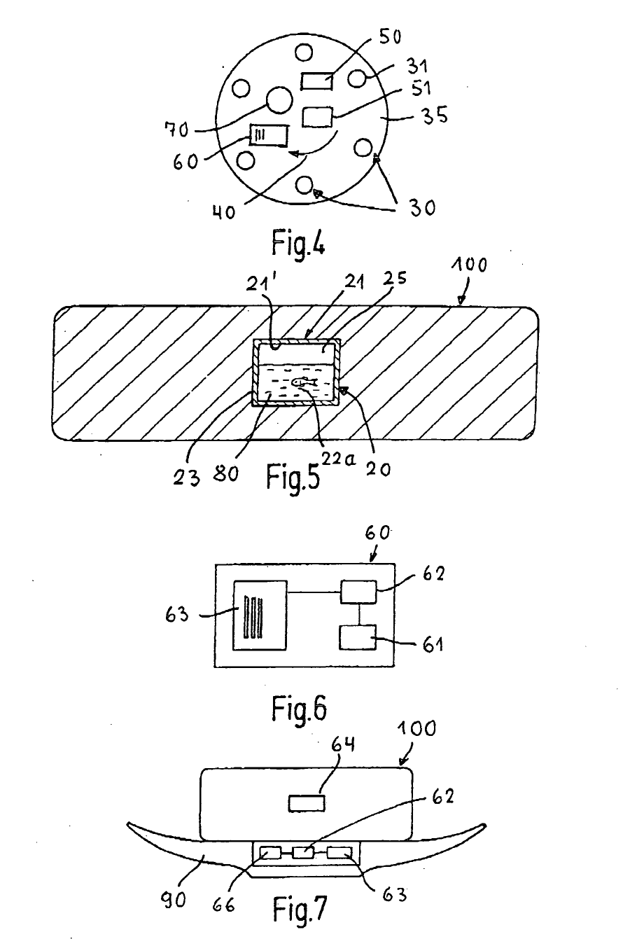

According to FIG. 3 at least one luminous means is placed in the inner space 25 of the moulded body 21. Preferably a number of colour light or white light emitting lamps or luminescent diodes 31 are provided as luminous means. These lamps or luminescent diodes 31 are switched in a running light 40 which is time-controlled by means of a control device 50 so that the lamps or luminescent diodes 31 alternately emit preferably the one after the other colour light or white light (FIG. 4, 8 and 9).

The arrangement of the lamps or luminescent diodes 31, of the control device 50 and of a current source 70 for the luminous means 30 is made on a switchboard 35 which is placed in the moulded body 21 configured as a hollow body 21′. According to FIG. 3, this arrangement of these components is made in the inner space 25 of the moulded body 21 configured as a fish 22a.

The moulded body 21 which has a figurative conformation 22 or a geometrical conformation 23 is provided as hollow body 21′ with an impermeable and moisture-proof closable opening 26, whereby the closure of this opening 26 is made by a sealing cap 27 (FIG. 3).

The control device 50 provided with a motion switch 51 as a first on-off switch 50 is actuatable by a second mechanical on-off switch 55 and can be locked for transport. The control device 50 is set working and deactivated by means of the on-off switch so that the motion switch 51 is activated in such a manner that the luminous means 30 is switched on with its luminescent diodes 31 in such a way that the luminescent diodes 31 light up the one after the other as running light and then emit white or colour light.

The moulded body 21 in its figurative conformation can be placed in an envelope 28 which is made of two half-shell components 28a, 28b which can be stuck together (FIG. 2). The moulded body 21 which has the figurative conformation 22 is then placed in the inner space 25 formed by the envelope 28. However it is also possible to place the moulded body 21 configured as a figure in an envelope which has a geometrical conformation 23 (FIG. 1). Both half-shell components 28a, 28b of th envelope 28 are connected impermeable and moisture-proof to each other.

As FIG. 4 shows the moulded body 21 configured as a hollow body 21′ can have a liquid medium 80 in its inner space 25 in which the moulded body 21 is placed with its figurative conformation 22 as a fish 22a so that a soap 100 is obtained in the soap body 11 of which an aquarium is placed (FIG. 5).

Furthermore a speech and/or music module 60 which is preferably placed in the moulded body 21 is integrated in the soap body 11 of the soap 100 (FIG. 1 and 3). This speech and/or music module 60 comprises a current source 70, a sensor 61, a storage unit 62 and an acoustic reproduction device, for example in form of a loudspeaker (FIG. 1, 6 and 7). The activation or control of the speech and/or music module 60 takes place in the same manner as the luminous means 30. The speech and/or music module 60 which can be programmable or which is preprogrammed or which is recordable is placed in the hollow space 21′ of the moulded body 21, either alone for itself or in connection with the luminous means 30. In the latter case the activation or at least the switching-on of the luminous means 30 and of the speech and/or music module 60 is made by the control device 50 in connection with the motion switch 51 which is again activated by the on-off switch 55, whereby this on-off switch 55 can be actuated from outside which is indicated by the arrow Y in FIG. 2 and 3. Here the switch is configured as a press switch. In order to be able to activate the switch 55, it passes through the soap mass of the soap body 11 of the soap 100 so that a switch actuation is possible.

As FIG. 1 shows, according to a further embodiment, the speech and/or music module 60 is placed in the soap body 11 of the soap 100. The speech and/or music module 60 can be fitted for emitting acoustic sounds and/or for emitting light. The soap 100 is configured as a soap bar 10, whereby an application for liquid soap is also possible. The speech and/or music module 60 is placed inside the soap bar 10 approximately in the middle so that the user can wash his hands with the soap without any disadvantage and the function is maintained until the end of the use of the soap.

In FIG. 6 the speech and/or music module 60 can be recognized with a motion sensor 61, a storage unit 62 and an acoustic reproduction device 63. The reproduction device 63 serves for the reproduction of acoustic sounds and can comprise alternatively or additionally one or several luminescent diodes 31 of the same or of different colour for the restitution of light. Of course the speech and/or music module 60 also possesses an energy supply, for example over a current source such as a battery. The motion sensor 61 can consist for example of a mass body which changes its position due to gravity or inertia and thus closes or opens a contact which is not represented. The signal of the motion sensor 51 is transmitted to the storage unit 62 so that a sequence of acoustic sounds and/or a sequence of light signals stored therein is called and transmitted to the reproduction device 63 for reproduction. The sequence of sounds or of light signals can be stored or can also be entered or changed individually from outside. This is easily possible with the wireless data transmission. Melodies, advertising slogans, warning indications, indications for use or even funny phrases are conceivable as sequences of sounds. Regular or even irregular flashing is conceivable as sequences of light signals, whereby the flashing can also be extended to a play of colours by activating luminescent diodes 31 of different colours.

In FIG. 7 an alternative embodiment is represented with a speech and/or music module 60 made of a passive part 64 and of an active part 65. The passive part 64 can for example be a transponder or a magnet. The active part 65 is placed in a soap dish 90 and has an energy supply which is not represented such as for example a battery. Moreover a sending unit 66 and a storage unit 62 and a reproduction unit 63 are provided according to FIG. 5. The sending unit 66 emits a frequency orientated in direction of the passive part 64 and also a magnetic field. The passive part 64 is configured as a transponder or as a magnet. When the passive part 64 is moving, the active part 65 is influenced so that finally a signal is produced and thus the reproduction of the sequence of sounds from the storage unit is released over the reproduction unit 63.

Basically the movement of the soap 100 which releases the signal can consist in a lifting, a wrong depositing or even in an use which is not appropriate for the purpose. Alternatively an activation of the speech and/or music module 60 would also be conceivable with the switching-on of the bathroom light, if the soap is touched. The speech and/or music module 60 can moreover comprise a time meter so that the reproduction of the sounds or of the light takes place only after a predetermined duration, for example for prompting for washing the hands after having been to the toilet.

The luminous means 30 is also activable in the same way as the speech and/or music module 60 can be triggered. The speech and/or music module 60 can be placed separately in the inner space of the moulded body 21. The speech and/or music module 60 can be also placed on the switchboard which carries the luminous means and the electronic control elements for the luminescent diodes 31.

As FIG. 3, 4 and 8 show, several luminescent diodes 31 which can be placed in form of a circle or in a row are combined as a luminous means 30. These luminescent diodes 30 are switched as a running light 40. The luminescent diodes go out after a predetermined time over the control device 50 which also comprises among others a time switch. It is also possible to operate the luminescent diodes 31 by an usual commercial switch 55, whereby the luminescent diodes can also be permanently working so that they permanently light. If the luminescent diodes 31 should not emit any light any longer, by activating the switch which can then be an on-off switch the luminescent diodes are switched off, whereby the switching off can also be induced over the time switch.

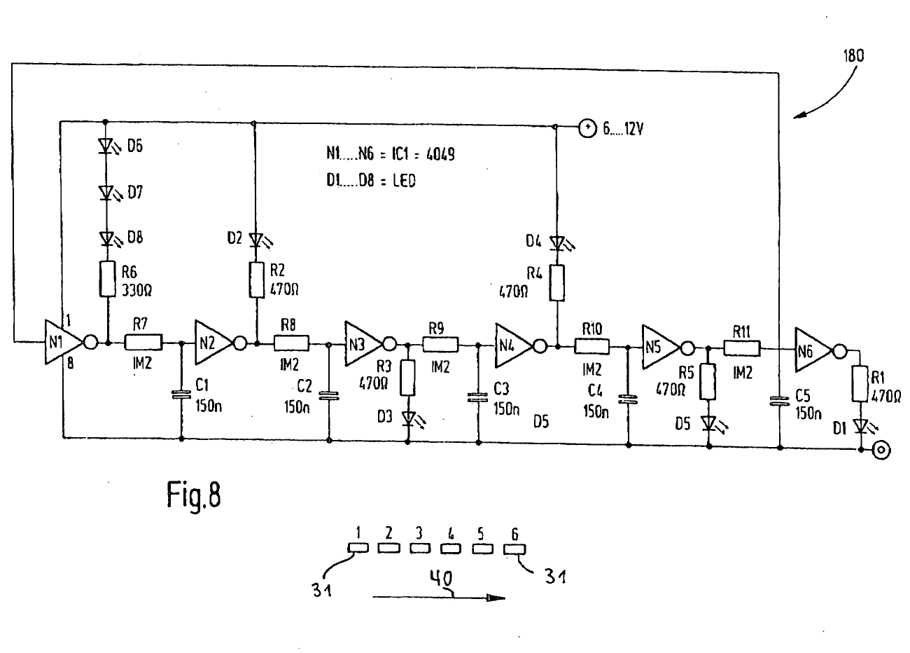

FIG. 8 shows a circuit for such a running light 40. This running light 40 consists of a number of luminescent diodes 31 which are placed in a row. Six luminescent diodes 31 are provided for the embodiment according to FIG. 8. The circuit is mounted with only an IC which however contains six inverters. Each inverter is switched with a RC network at the outlet. The inverter outlet must thus first charge a capacitor over the resistor before the next inverter can be triggered. The luminescent diodes are triggered gradually by this circuit. This being this IC is dimensioned in such a way that it can easily control the luminescent diodes. The whole circuit only needs for example approximately 50 mA and can thus be operated without any problem with a 9 V battery.

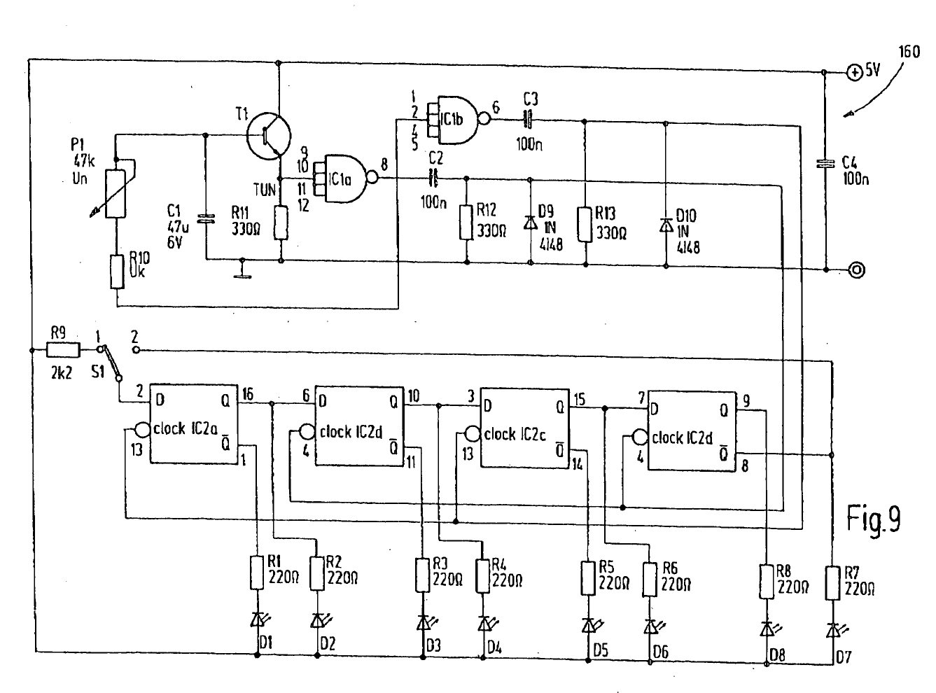

The circuit represented in FIG. 9 for a running light 40 is used for a greater number of luminescent diodes 31. Here for example eight luminescent diodes are on the Q and O outlets of four data flip-flops. This being, four luminescent diodes always light, whereas the other luminescent diodes are switched off. If the control commands change at the information inlets of the flip-flops, the luminescent diodes of the luminescent diodes connected at the outlets go out. The control of the flip-flops is such that, when the luminous condition of a “group of four” changes to the next one, there results a very nice travelling effect. Referring to the circuit according to FIG. 9, the circuit starts with S1. When the supply voltage is switched on, this switch must be in position 1; a “1” then arrives to the data input of the first flip-flop. The switch remains in position 1 until the “1” entered at the beginning runs through the whole chain; then the switch is brought into position 2. The O output of the last flip-flop is then connected to the data input of the first flip-flop. The further cycles proceed automatically. The loading and unloading time of the capacitor C1 is decisive for the frequency of the control pulses. Since both times depend among others on the value of the resistor in the base circuit (P1 and R10), one can adjust with 1 the frequency of the control pulses and thus the frequency of the running light. The eight luminescent diodes emit relatively little light, therefore the circuit in the indicated embodiment is appropriate for example for a domestic use. If the luminescent diodes are replaced by optocouplers, other lamps, such as for example small filament lamps, can be controlled by appropriate power stages. Besides luminescent diodes and the running light 40 with white light emission, they can also be configured such that colour light is emitted.

What is claimed is:

1. Soap, in particular soap bar (100), the soap body (11) of which is made of a transulucent or clear or not translucent soa mass,
characterized in
that a two- or three-dimensional moulded body (21) with a figurative conformation (22) or with a geometrical conformation (23) is placed in the soap body (11), whereby at least one luminous means (30) and/or a speech and/or music module (60) are placed in the moulded body (21), the luminous means (30) is connected to a power supply and can be activated and time-controlled by means of a control device (50) with a first on-off switch or a motion switch (51) which again is operatively connected to a second on-off switch (55).

2. Soap according to claim 1,
characterized in
that a representational two- or three dimensional insert body (20) in form of a figurative conformation (22) or of a moulded body (21) with a geometrical conformation (23) is placed in the soap body (11), whereby at least one luminous means (30), preferably a number of lamps or luminescent diodes (31) emitting colour light or white light in form of a time-controlled running light (40) circulating by means of a control device (50) and/or a programmable, preprogrammed or recordable speech and/or music module (60) are placed in the inner space (25) of the moulded body (21), whereby the control device (50) for the actuation of the lamps or luminescent diodes (31) and/or of the speech and/or music module (60) are operatively connected to a first on-off switch or a motion switch (51) and are operatively connected to at least one current source (70), whereby the first on-off switch or the motion switch (51) is activable with a second on-off switch (55).

3. Soap according to any of the claims 1 or 2,
characterized in
that the moulded body (21) which has a figurative conformation (22) or a geometrical conformation (23) is provided as a hollow body (21′) with an impermeable and moisture-proof closable opening (26).

4. Soap according to any of the claims 1 to 3,
characterized in
that the motion switch (51) for the control device (50) is controllable by the second mechanical on-off switch (55) and is locked for transport.

5. Soap according to any of the claims 1 to 4,
characterized in
that the moulded body (219 which has a figurative conformation (22) is placed in the inner space of an envelope (28).

6. Soap according to any of the claims 1 to 5,
characterized in
that the moulded body (21) which has a geometrical conformation (23) or the envelope (28) is made of two half-shell components (28a, 28b) which can be stuck together.

7. Soap according to any of the claims 1 to 6,
characterized in
that the moulded body (21) with the figurative conformation (22) is placed together with a liquid medium (80) in the inner space (25) of the moulded body (21) which is configured as a closed hollow body (21′) and which has a geometrical conformation (23).

8. Soap according to any of the claims 1 to 7,
characterized in
that at least one luminous means (30) such as luminescent diodes (31), a current source (32) such as a battery and an on-off switch activable by motion are placed in the inner space (25) of the moulded body (21) configured as a hollow body (21′) between the luminous means(36) and the current source (32).

9. Soap according to any of the claims 1 to 7,
characterized in
that the device for the reproduction of information which is configured as a speech and/or music module (60) for the acoustic reproduction of sounds and/or the emission of light is placed in the moulded body (21) configured as a hollow body (21′).

10. Soap according to claim 9,
characterized in
that the luminous means (30) and/or the speech and/or music module (60)
is activable by motion and/or contact of the moulded body (21) or of the soap bar (10) or
is deactivated in a predetermined position of the soap bar (10) or
has a sensitive sensor (61) with respect to external movements and/or movements of the soap bar (10) itself or a sensor for detecting biometric data or
comprises a light-sensitive sensor or
has a storage unit (62) in which a predetermined sequence of sounds is deposited and has an acoustic reproduction unit (63) and the predetermined sequence of sounds can be reproduced by the acoustic reproduction unit (63) by emitting a signal of one of the provided sensors.

11. Soap according to any of the claims 1 to 10,
characterized in
that the lamps or luminescent diodes (31) of the luminous means (30) are switched in such a manner that the light can be emitted in the art of pulses, whereby the light pulses and the sounds of the speech and/or music module (60) are adapted to each other.
